(19) United States
(12) Patent Application Publication
(10) Pub. No.: US 2025/0196616 A1
(43) Pub. Date: Jun. 19, 2025

(54) MODULAR AND INTEGRATED ELECTRIC VEHICLE DRIVING AND STEERING SYSTEM

(71) Applicants: DENSO International America, Inc., Southfield, MI (US); DENSO CORPORATION, Kariya-city (JP)

(72) Inventors: Swanand LIMAYE, Farmington Hills, MI (US); Guriqbal SINGH, Belle River (CA); Kenji MORIKAWA, Kariya-City (JP); Sergio PUJOLS, Canton, MI (US); Robert BRINKER, Ortonville, MI (US)

(73) Assignees: DENSO International America, Inc., Southfield, MI (US); DENSO CORPORATION, Kariya-city (JP)

(21) Appl. No.: 18/979,895

(22) Filed: Dec. 13, 2024

Related U.S. Application Data
(60) Provisional application No. 63/610,146, filed on Dec. 14, 2023.

(51) Int. Cl. B60K 7/00; B60G 3/20

(52) U.S. Cl. CPC B60K 7/0007; B60G 3/20; B60G 2200/144; B60G 2200/156; B60G 2300/50; B60K 2007/0038

(57) ABSTRACT

An electric vehicle propulsion, steering, and suspension system including an in-wheel motor located within or proximate to a tire assembly, an integrated inverter, a direct steering motor, a brake-by-wire system, and a double wishbone suspension. The double wishbone suspension includes an upper wishbone arm and a lower wishbone arm, each having proximal and distal end points. The proximal end points are pivotally connected to the vehicle chassis. The distal end points are connected to a knuckle assembly attached to the tire assembly.

### CROSS-REFERENCE TO RELATED APPLICATION

This application claims the benefit of U.S. Provisional Application No. 63/610,146, filed on Dec. 14, 2023. The entire disclosure of the above application is incorporated herein by reference.

### FIELD

The present disclosure relates to a modular and integrated electric vehicle driving and steering system.

### BACKGROUND

This section provides background information related to the present disclosure which is not necessarily prior art.

Electric vehicles have predominantly utilized a centralized powertrain architecture. This conventional design typically involves a single electric motor or a pair of motors that drive the vehicle, connected to the wheels through a transmission system. Conventional electric powertrains feature a standard, centralized arrangement of components, including the motor, transmission, and often the battery pack. However, the centralized powertrain architecture imposes several limitations which the present disclosure overcomes.

### SUMMARY

This section provides a general summary of the disclosure, and is not a comprehensive disclosure of its full scope or all of its features.

The present disclosure provides for, in various features, an electric vehicle propulsion, steering, and suspension system, including a tire assembly coupled to an in-wheel motor and a knuckle assembly, wherein the in-wheel motor is configured to drive the knuckle assembly, a direct steering motor coupled to a gear assembly and configured to rotate the gear assembly which is further rotatably coupled to a double wishbone suspension such that rotating the gear assembly rotates the double wishbone suspension, and the double wishbone suspension including an upper wishbone arm and a lower wishbone arm, each having proximal and distal end points, wherein the proximal end points pivotally coupled to the vehicle and the distal end points coupled to the knuckle assembly.

In various additional features, the direct steering motor is located above the upper wishbone arm.

In various additional features, the upper wishbone arm is located at approximately the same height as the in-wheel motor.

In various additional features, the system further includes a torque vectoring system configured to apply torque directly through the in-wheel motors to each wheel and selectively steer each wheel based on real-time feedback from sensors.

In various additional features, the sensors include at least one tire pressure monitoring sensor configured to provide feedback to the torque vectoring system to adjust torque based on tire inflation levels.

In various additional features, the torque vectoring system further includes a predictive algorithm configured to anticipate vehicle dynamics based on driver input and road conditions.

In various additional features, the system is included in a module configured to be attached to a platform for an electric vehicle.

In various additional features, the system further includes an integrated cooling system configured to dissipate heat generated during operation.

In various additional features, the system further includes a regenerative braking system.

In various additional features, the in-wheel motor is integrated within the tire assembly.

The present disclosure includes, in various features, an electric vehicle propulsion, steering, and suspension system including a double wishbone suspension including an upper wishbone arm and a lower wishbone arm, each having proximal and distal end points, wherein the proximal end points are pivotally coupled to the vehicle and the distal end points are coupled to a knuckle assembly, a direct steering motor located above the upper wishbone arm, coupled to a gear assembly, and configured to rotate the gear assembly which is further rotatably coupled to the double wishbone suspension such that rotating the gear assembly rotates the double wishbone suspension, and a tire assembly coupled to an in-wheel motor and the knuckle assembly, wherein the in-wheel motor is configured to drive the knuckle assembly.

In various additional features, the upper wishbone arm is located at approximately the same height of the in-wheel motor.

In various additional features, a torque vectoring system is included and configured to apply torque directly through the in-wheel motors to each wheel and selectively steer each wheel based on real-time feedback from sensors.

In various additional features, the sensors include at least one tire pressure monitoring sensor configured to provide feedback to the torque vectoring system to adjust torque based on tire inflation levels.

In various additional features, the torque vectoring system further includes a predictive algorithm configured to anticipate vehicle dynamics based on driver input and road conditions.

In various additional features, the system is included in a module configured to be attached to a platform for an electric vehicle.

In various additional features, an integrated cooling system is included and configured to dissipate heat generated during operation.

In various additional features, a regenerative braking system is included.

In various additional features, the in-wheel motor is integrated within the tire assembly.

The present disclosure further includes, in various features, a platform for an electric vehicle, including a main body, a battery contained within the main body, and at least one electric vehicle propulsion, steering, and suspension system including an electric vehicle propulsion, steering, and suspension system, including a tire assembly coupled to an in-wheel motor and a knuckle assembly, wherein the in-wheel motor is configured to drive the knuckle assembly, a direct steering motor coupled to a gear assembly and configured to rotate the gear assembly which is further rotatably coupled to a double wishbone suspension such that rotating the gear assembly rotates the double wishbone suspension, and the double wishbone suspension including an upper wishbone arm and a lower wishbone arm, each having proximal and distal end points, wherein the proximal end points pivotally coupled to the vehicle and the distal end points coupled to the knuckle assembly.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle platform with four electric vehicle propulsion, steering, and suspension systems according to the present disclosure;

FIG. 2 illustrates one of the electric vehicle propulsion, steering, and suspension systems of FIG. 1;

FIG. 3A is a schematic view of a brake-by-wire system according to the present disclosure installed in an exemplary vehicle;

FIG. 3B is a block diagram of a brake-by-wire system according to the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The present disclosure advantageously decentralizes the powertrain into four independent modules, each integrated into a wheel of the vehicle. This approach allows for a more flexible vehicle design, as it eliminates the need for a central powertrain and transmission shaft, leading to a more efficient use of space and potentially reducing the vehicle's overall weight.

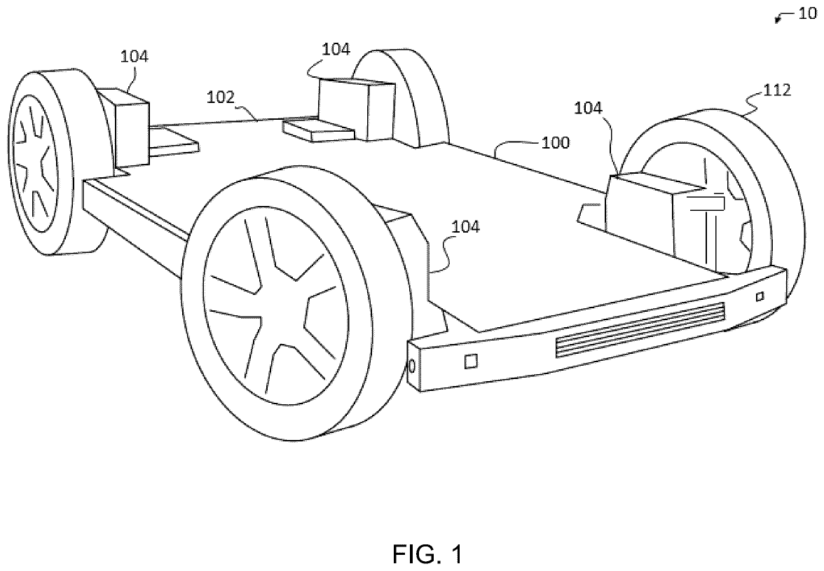

FIG. 1 illustrates an example platform assembly 100 for an electric vehicle 10. The example platform is a skateboard chassis, but other electric vehicle platforms may be contemplated. Different forms of electric vehicles may also be contemplated, including, but not limited to, plug-in hybrid electric vehicle (PHEV), battery electric vehicle (BEV), range-extended electric vehicles (REEV).

Platform assembly 100 is particularly configured for pickup trucks, but other vehicle types may also be contemplated, including, but not limited to, light trucks, sporty utility vehicles (SUVs), crossover utility vehicles (CUVs), vans, and off-road vehicles.

In the depicted example, the electric vehicle 10 includes a platform assembly 100. The platform assembly 100 includes a main body 102 and at least one electric vehicle propulsion, steering, and suspension system 104. In one example, the electric vehicle propulsion, steering, and suspension system 104 may be packaged as a module. The module may be a self-contained assembly including all of the features of the electric vehicle propulsion, steering, and suspension system 104. The module may be configured to attach to the main body of a platform assembly. The module may further include a braking element and an anti-locking braking system (ABS). Examples of a braking element include, but are not limited to disc brakes, drum brakes, electromagnetic brakes, and regenerative brakes.

The module may include a “plug and play” design to allow the module to more easily connect to the chassis or main body 102. Once attached to the chassis or main body 102, the module may be secured with a plurality of bolts or a single bolt. A plurality of bolts may include two bolts, three bolts, four bolts, five bolts, or more.

The module may further include a plurality of connection points, including coolant lines, HV cables, and communication cables. These connections may connect to or interface with matching connection points on the chassis or main body 102. The module may be configured to be attached to a vehicle platform on a production line.

The main body 102 forms the foundational structure. The main body 102 may contain a battery (not shown). As depicted, the main body is physically connected to four electric vehicle propulsion, steering, and suspension systems 104, but a greater or lesser number of electric vehicle propulsion, steering, and suspension systems 104 may be contemplated. The electric vehicle propulsion, steering, and suspension system 104 is discussed in more detail below.

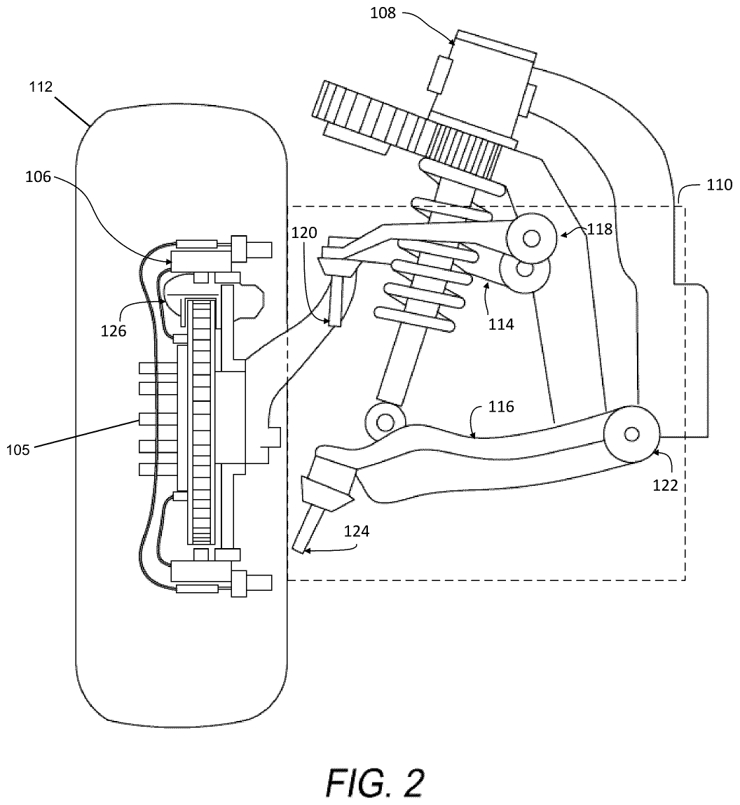

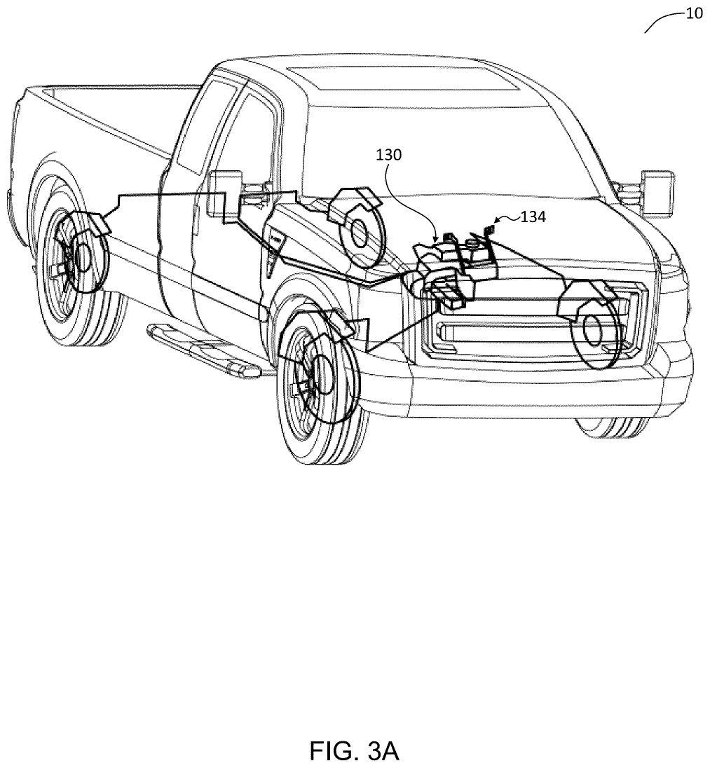

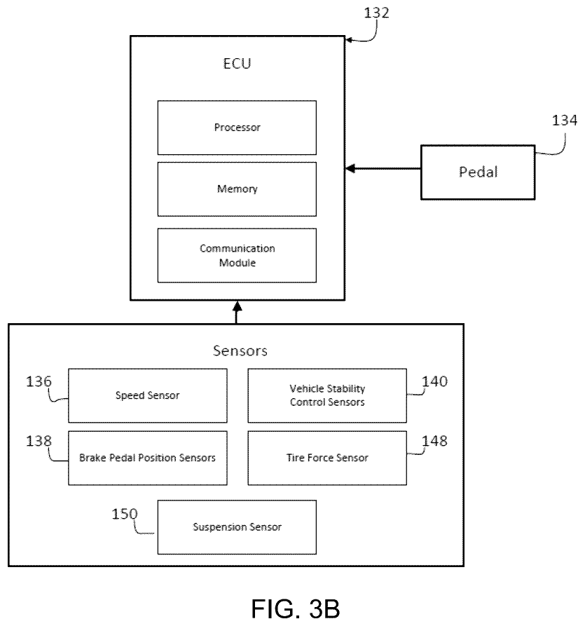

FIG. 2 illustrates an example electric vehicle propulsion, steering, and suspension system 104. Each electric vehicle propulsion, steering, and suspension system 104 includes an in-wheel motor 106, an integrated inverter 107, a direct steering motor 108, a brake-by-wire system 130 (FIGS. 3A and 3B, for example), and a double wishbone suspension 110. In another example, the electric vehicle propulsion, steering, and suspension system 104 may further include an integrated cooling system (not shown). The integrated cooling system may be connected to and deliver coolant to one or more of the in-wheel motor 106, the integrated inverter 107, and the direct steering motor 108.

The in-wheel motor 106 may be located within or proximate to a tire assembly 112. The in-wheel motor 106 may be an electric drive motor (EDM). The in-wheel motor 106 may form a ring within the tire assembly 112. The in-wheel motor 106 is configured to drive the tire of the tire assembly 112.

The direct steering motor 108 may be attached to the top of the electric vehicle propulsion, steering, and suspension system 104. The direct steering motor 108 may include an electric motor and may be coupled to a gear assembly 142. The gear assembly 142 may be further coupled to the double-wishbone suspension 110 such that, when the gear assembly 142 is rotated by the direct steering motor 108, the electric vehicle propulsion, steering, and suspension system 104 is rotated.

The brake-by-wire system 130 (see FIGS. 3A and 3B, for example), may include an electronic control unit (ECU) 132, a number of brake actuators 126, a pedal feel simulator 134, and a number of sensors 136, 138, 140, 148, 150. The ECU 132 may receive input from a number of sensors, including, but not limited to, wheel speed sensors 136, brake pedal position sensors 138, vehicle stability control sensors 140, and tire pressure monitoring sensors (not shown). The ECU 132 processes this data to determine the appropriate braking force for each wheel, ensuring optimal braking performance under varying conditions. Each tire assembly 112 is equipped with a brake actuator 126, which directly applies the braking force to the wheel. The brake actuator 126 may include or be a component of a hydraulic, electronic, or magnetic braking system. These brake actuators 126 are controlled by the ECU 132 and are capable of precise and rapid modulation of braking force.

As illustrated in FIG. 2, for example, the double wishbone suspension 110 includes an upper wishbone arm 114 and a lower wishbone arm 116, each having at least one proximal end point 118, 120 and at least one distal end point 122, 124 (proximal indicating the end point nearest the center of the vehicle 10 and distal indicating the end point furthest from the center of the vehicle 10). The proximal end points of both wishbone arms 114, 116 are pivotally connected to the chassis of the vehicle, allowing for vertical movement. The distal end points of the wishbone arms 114, 116 are connected to a knuckle assembly 105, which, in turn, is attached to the tire assembly 112.

The double-wishbone suspension typical of light trucks presents design challenges for the electric vehicle propulsion, steering, and suspension system 104. The electric vehicle propulsion, steering, and suspension system 104 requires a large number of components to occupy a limited amount of space in the tire assembly 112. The double-wishbone suspension 110 is particularly configured to accommodate the space needs of these components.

The lower wishbone arm 116 has been shortened relative to a typical double-wishbone suspension to accommodate the space needs of the components and reduce the unsprung mass of the vehicle 10. The length of the lower wishbone arm 116 may be reduced proportionally to the reduction of the distance between the upper wishbone arm 114 and lower wishbone arm 116. In another example, a subframe design may be used allowing the electric vehicle propulsion, steering, and suspension system 104 to move with the wheel.

The upper wishbone arm 114 has also been lowered relative to the tire assembly 112 to reduce the overall height of the electric vehicle propulsion, steering, and suspension system 104 and increase the size of the frunk space. Lowering the upper wishbone arm 114 reduces the distance between the upper wishbone arm 114 and the lower wishbone arm 116 and alters the roll center of the vehicle 10. The roll center is a virtual point in a vehicle around which the chassis rolls, significantly influencing handling during cornering. Torque vectoring techniques may be applied to address the changes in the vehicle roll center.

For example, applying torque directly through the in-wheel motors 106 to each wheel and selectively steering each wheel according to real-time feedback provided by vehicle sensors may improve stability. In another example, torque vectoring may include algorithmic control and monitoring of a number of vehicle sensors including a tire force sensor 148 which measures the force being applied to a tire by the pavement. Algorithmic control and monitoring of sensors may further include, but is not limited to, other common vehicle sensors, such as the speed sensors 136 that monitor the speed of the vehicle 10 and suspension sensors 150 that monitor the motion of the suspension.

The unsprung mass is that part of the vehicle that is not supported by springs (e.g. tires, nuts, linkages). This is an especially important concern in an electric vehicle propulsion, steering, and suspension system 104 as the electric vehicle propulsion, steering, and suspension system 104 moves components, such as the electric drive motor 106, into the wheel, increasing the unsprung mass. An increased unsprung mass results in a slower wheel reaction time to events like potholes, meaning it takes longer for the wheel to rise back from the pothole due its mass. This extra mass has an overall impact on handling and stability. In another example, the above torque vectoring techniques may be applied to overcome the handling issues introduced by the increased unsprung mass.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

A module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

A module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of a module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. An electric vehicle propulsion, steering, and suspension system, comprising:
a tire assembly coupled to both a knuckle assembly and an in-wheel motor, the in-wheel motor configured to drive the knuckle assembly;
a direct steering motor coupled to a gear assembly and configured to rotate the gear assembly;
a double wishbone suspension system to which the gear assembly is rotatably coupled such that rotating the gear assembly rotates the double wishbone suspension; and
an upper wishbone arm and a lower wishbone arm of the double wishbone suspension system, each one of the upper wishbone arm and the lower wishbone arm including proximal end points and distal end points, the proximal end points are pivotally coupled to the vehicle and the distal end points are coupled to the knuckle assembly.

2. The electric vehicle propulsion, steering, and suspension system of claim 1, wherein the direct steering motor is located above the upper wishbone arm.

3. The electric vehicle propulsion, steering, and suspension system of claim 1, wherein the upper wishbone arm is located at approximately the same height of the in-wheel motor.

4. The electric vehicle propulsion, steering, and suspension system of claim 1, further comprising a torque vectoring system configured to apply torque directly through the in-wheel motor to the wheel and selectively steer the wheel based on real-time feedback from sensors.

5. The electric vehicle propulsion steering and suspension system of claim 4, wherein the sensors include at least one tire pressure monitoring sensor configured to provide feedback to the torque vectoring system to adjust torque based on tire inflation levels.

6. The electric vehicle propulsion steering and suspension system of claim 4, wherein the torque vectoring system further comprises a predictive algorithm configured to anticipate vehicle dynamics based on driver input and road conditions.

7. The electric vehicle propulsion, steering, and suspension system of claim 1 included in a module configured to be attached to a platform for an electric vehicle.

8. The electric vehicle propulsion steering and suspension system of claim 1, further comprising an integrated cooling system configured to dissipate heat generated during operation.

9. The electric vehicle propulsion steering and suspension system of claim 1, further comprising a regenerative braking system.

10. The electric vehicle propulsion steering and suspension system of claim 1, wherein the in-wheel motor is integrated within the tire assembly.

11. An electric vehicle propulsion, steering, and suspension system, comprising:
a double wishbone suspension including an upper wishbone arm and a lower wishbone arm each having proximal end points pivotally coupled to the vehicle and distal end points coupled to a knuckle assembly;
a direct steering motor above the upper wishbone arm, the direct steering motor coupled to a gear assembly and configured to rotate the gear assembly, the gear assembly is rotatably coupled to the double wishbone suspension such that rotation of the gear assembly rotates the double wishbone suspension; and
a tire assembly coupled to a knuckle assembly and an in-wheel motor that is configured to drive the knuckle assembly.

12. The electric vehicle propulsion, steering, and suspension system of claim 11, wherein the upper wishbone arm is located on the same vertical plane as the in-wheel motor.

13. The electric vehicle propulsion, steering, and suspension system of claim 11, further comprising a torque vectoring system configured to apply torque directly through the in-wheel motor to the wheel and selectively steer the wheel based on real-time feedback from sensors.

14. The electric vehicle propulsion steering and suspension system of claim 13, wherein the sensors include at least one tire pressure monitoring sensor configured to provide feedback to the torque vectoring system to adjust torque based on tire inflation levels.

15. The electric vehicle propulsion steering and suspension system of claim 13, wherein the torque vectoring system further comprises a predictive algorithm configured to anticipate vehicle dynamics based on driver input and road conditions.

16. The electric vehicle propulsion, steering, and suspension system of claim 11 included in a module configured to be attached to a platform for an electric vehicle.

17. The electric vehicle propulsion steering and suspension system of claim 11, further comprising an integrated cooling system configured to dissipate heat generated during operation.

18. The electric vehicle propulsion steering and suspension system of claim 11, further comprising a regenerative braking system.

19. The electric vehicle propulsion steering and suspension system of claim 10, wherein the in-wheel motor is integrated within the tire assembly.

20. A platform for an electric vehicle, comprising:
a main body;
a battery contained within the main body; and
at least one electric vehicle propulsion, steering, and suspension system comprising:
a tire assembly coupled to both a knuckle assembly and an in-wheel motor, the in-wheel motor configured to drive the knuckle assembly;
a direct steering motor coupled to a gear assembly and configured to rotate the gear assembly;
a double wishbone suspension system to which the gear assembly is rotatably coupled such that rotating the gear assembly rotates the double wishbone suspension; and
an upper wishbone arm and a lower wishbone arm of the double wishbone suspension system, each one of the upper wishbone arm and the lower wishbone arm including proximal end points and distal end points, the proximal end points are pivotally coupled to the vehicle and the distal end points are coupled to the knuckle assembly.
